(19) United States
(12) Patent Application Publication
(10) Pub. No.: US 2019/0063950 A1
(43) Pub. Date: Feb. 28, 2019

(54) TECHNIQUES FOR REDUCING POWER CONSUMPTION IN MAGNETIC TRACKING SYSTEM

(71) Applicant: Microsoft Technology Licensing, LLC, Redmond, WA (US)

(72) Inventor: Sam Michael SARMAST, Redmond, WA (US)

(21) Appl. No.: 15/688,512

(22) Filed: Aug. 28, 2017

(51) Int. Cl. G01D 5/14; G01P 3/487; G01P 13/04; G01B 21/22; G01B 7/004; G01C 17/38; G01C 21/16

(52) U.S. Cl. CPC G01D 5/145; G01P 3/487; G01P 13/045; G01C 21/165; G01B 7/004; G01C 17/38; G01B 21/22

(57) ABSTRACT

The devices and methods for sending reduced power signals include transmitting a first magnetic signal to a remote device, receiving a first position data from the remote device based on the first magnetic signal, wherein the first position data indicates a first position of the remote device relative to the local device, receiving an indication signal indicating a rapid movement, wherein the rapid movement includes a velocity or an acceleration of the remote device achieving a threshold, transmitting a reduction signal indicating a reduction in a first power of the first magnetic signal in response to receiving the indication signal, transmitting a second magnetic signal based on transmitting the reduction signal, wherein the second magnetic signal has a second power lower than the first power, and receiving a second position data from the remote device based on the second magnetic signal, wherein the second position data indicates a second position of the remote device relative to the local device.

### BACKGROUND

Computing devices often support the use of wireless input devices, such as a stylus, a gaming controller, or other remoted devices, for providing input to applications executing on the computing devices. As such, many applications may require mechanisms for detecting the position of a remote device. Magnetic tracking offers a possible way for a local device, such as a computing device, to determine the position of the remote device, such as a wireless input device. A magnetic tracking system may include a transmitter (local device or remote device) of a magnetic signal and a receiver (remote device or local device) of the magnetic signal. As the transmitter sends out a magnetic signal of predetermined amplitude and frequency, the receiver uses the detected magnetic signal to determine its position and orientation relative to the transmitter. The transmission of magnetic signal, however, can require significant electrical power. Where the transmitter relies on battery for electrical power, extensive transmission of the magnetic signal may prevent prolonged usage of the transmitter.

Therefore, improvements in power reduction techniques for transmitters in a magnetic tracking system may be desirable.

### SUMMARY

The following presents a simplified summary of one or more features described herein in order to provide a basic understanding of such features. This summary is not an extensive overview of all contemplated features, and is intended to neither identify key or critical elements of all features nor delineate the scope of any or all implementations. Its sole purpose is to present some concepts of one or more features in a simplified form as a prelude to the more detailed description that is presented later.

A method and system for sending reduced power signals include transmitting a first magnetic signal to a remote device, receiving a first position data from the remote device based on the first magnetic signal, wherein the first position data indicates a first position of the remote device relative to the local device, receiving an indication signal indicating a rapid movement, wherein the rapid movement includes a velocity or an acceleration of the remote device achieving a threshold, transmitting a reduction signal indicating a reduction in a first power of the first magnetic signal in response to receiving the indication signal, transmitting a second magnetic signal based on transmitting the reduction signal, wherein the second magnetic signal has a second power lower than the first power, and receiving a second position data from the remote device based on the second magnetic signal, wherein the second position data indicates a second position of the remote device relative to the local device.

A method and system for receiving reduced power signals include receiving a first magnetic signal having a first power from a local device, generating a first position data based on the first magnetic signal, transmitting the first position data to the local device, detecting a rapid movement of the remote device, wherein the rapid movement includes a velocity or an acceleration of the remote device exceeding a threshold, transmitting an indication signal indicating a detection of the rapid movement of the remote device in response to detecting the rapid movement, receiving a reduction signal indicating a reduction in the first power of the first magnetic signal based on transmitting the indication signal, receiving a second magnetic signal based on receiving the reduction signal, wherein the second magnetic signal has a second power lower than the first power, generating a second position data based on the second magnetic signal, and transmitting the second position data to the local device.

A method and system for sending reduced power signals include transmitting a first magnetic signal having a first power to a local device, detecting a rapid movement at the remote device, wherein the rapid movement includes a velocity or an acceleration of the remote device exceeding a threshold, transmitting a reduction signal indicating a decrease in the first power of the first magnetic signal based on detecting the rapid movement, and transmitting a second magnetic signal having a second power, wherein the second power is lower than the first power.

A method and system for receiving reduced power signals include receiving a first magnetic signal having a first power from a remote device, generating a first position data based on the first magnetic signal, wherein the first position data indicates a first position of the remote device relative to the local device, receiving a reduction signal indicating a reduction in the first power of the first magnetic signal, receiving a second magnetic signal based on receiving the reduction signal, wherein the second magnetic signal has a second power lower than the first power of the first magnetic signal, and generating a second position data based on the second magnetic signal, wherein the second position data indicates a second distance and a second orientation of the remote device relative to the local device.

The foregoing has outlined rather broadly the features and technical advantages of examples in order that the detailed description that follows may be better understood. Additional features and advantages will be described hereinafter. The conception and specific examples disclosed may be readily utilized as a basis for modifying or designing other structures for carrying out the same purposes of the present application. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

FIG. 1 is a block diagram of an example of a local device and remote device respectively configured for transmitting and receiving magnetic signals;

FIG. 2 is a block diagram of an example of a local device and remote device respectively configured for receiving and transmitting magnetic signals;

FIG. 3 is a block diagram of an example of the transmission of magnetic signals;

FIG. 4 is a block diagram of examples of magnetic signal transmitters and receivers, and associated magnetic signals;

FIG. 5 is a flow chart of an example of magnetic tracking method for the local device and remote device of FIG. 1;

FIG. 6 is a flow chart of an example of magnetic tracking method for the local device and remote device of FIG. 2;

FIG. 7 is a flow chart of an example of magnetic tracking method for the local device of FIG. 1;

FIG. 8 is a flow chart of an example of magnetic tracking method for the remote device of FIG. 1;

FIG. 9 is a flow chart of an example of magnetic tracking method for the local device of FIG. 2; and

FIG. 10 is a flow chart of an example of magnetic tracking method for the remote device of FIG. 2.

### DETAILED DESCRIPTION

The devices and methods for magnetic tracking, as described herein, provide for reducing power consumption of the transmitter in a magnetic tracking system. A magnetic tracking system may include a local device and a remote device, where the local device and/or remote device may track a position and/or orientation of the remote device with respect to the local device. A transmitter of the magnetic signal may be implemented in the local device, and a receiver may be implemented in the remote device, and/or vice versa. During operation, the local device may send a magnetic signal, having a certain electrical power, to the remote device. Based on the magnetic signal received, the remote device may generate position and/or orientation data. If the remote device detects a rapid movement (e.g., a velocity and/or acceleration of the remote device that achieves a threshold), an indication signal may be sent to the local device indicating a rapid movement. Based on receiving the indication signal, the local device may transmit a reduction signal indicating an impending reduction in power of magnetic signal, followed by the transmission of a reduced magnetic signal. The remote device uses the reduced magnetic signal to generate new position and/or orientation data. Reducing the signal power in this regard can allow for a reduction in power consumed by the local device while the remote device is rapidly moving. While this reduction in the magnetic signal may also reduce the accuracy and/or precision associated with the position and orientation of the remote device, this reduction occurs during a rapid movement, which may not require high accuracy and/or precision. At the end of the rapid movement, the local device may restore the output power of the magnetic signal back to the original power.

When the transmitter is implemented in the remote device, and the receiver is implemented in the local device, the remote device may modulate the power in the magnetic signal depending on its movement. During operation, the remote device may send the magnetic signal, having a certain electrical power, to the local device. Based on the magnetic signal received, the local device may generate the position and/or orientation data. If the remote device detects a rapid movement, it may transmit a reduction signal indicating an impending reduction in power of magnetic signal, followed by the transmission of the reduced magnetic signal. The local device uses the reduced magnetic signal to generate the new position and orientation data. Reducing the signal power in this regard can allow for a reduction in power consumed by the remote device while it is rapidly moving. At the end of the rapid movement, the remote device may restore the output power of the magnetic signal back to the original electrical power.

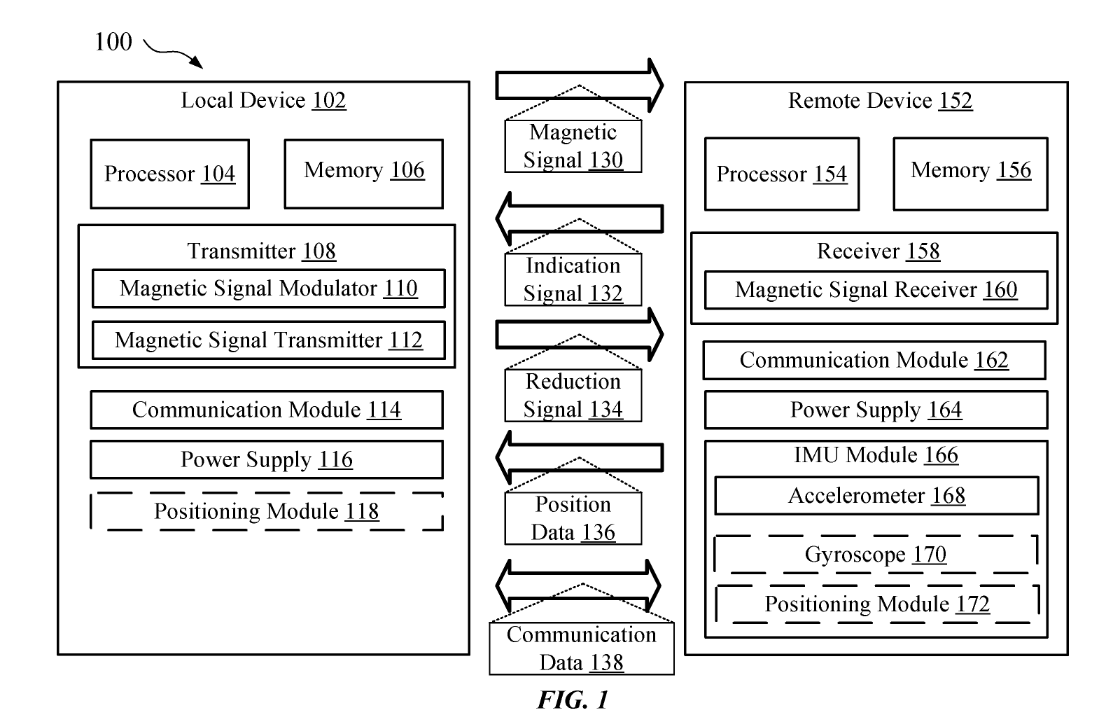

Referring now to FIG. 1, in some implementations, a magnetic tracking system 100 may include a local device 102 and remote device 152 that can communicate magnetic signals. For example, the local device 102 can include a processor 104 and a memory 106 configured to instantiate a transmitter 108 for modulating and sending a magnetic signal 130 to a remote device 152, which can include a processor 154 and a memory 156 configured to instantiate a receiver 158 for receiving the magnetic signal 130. The transmitter 108 includes a magnetic signal modulator 110 that modulates the power of the magnetic signal 130 by changing an amplitude, a frequency, a duty cycle etc., of the magnetic signal 130, and a magnetic signal transmitter 112 for transmitting the magnetic signal 130. A communication module 114 in the local device 102 may send and/or receive signals to/from a corresponding communication module 162 in the remote device 152, which may include signals other than magnetic signal 130. The communication module 114 and/or 162 may communicate via radio wave, Wi-Fi, Bluetooth, near-field communication (NFC), or any suitable wired and wireless communication technology. The local device 102 includes a power supply 116 that provides electrical power to the components of the local device 102. The power supply 116 may include a battery, an uninterrupted power supply, or a wall plug.

During operation, the transmitter 108 may send the magnetic signal 130, having an amplitude, frequency, and/or duty cycle, to the remote device 152. The receiver 158 of the remote device 152 may use a magnetic signal receiver 160 to detect the magnetic signal 130 sent by the transmitter 108. By detecting the magnetic signal 130 and/or measuring an amount of the magnetic signal 130 detected, the remote device 152 may generate data related to the magnetic signal 130, such as a spatial position and orientation of the remote device 152 using an optional positioning module 172, and can send position data 136 to the local device 102 with a communication module 162. Optionally, the positioning module 172 may include information from a gyroscope 170 to generate the position data 136. In another non-limiting example, an optional positioning module 118 may determine the spatial position and/or orientation of the remote device 152 based on data, sent by the communication module 162, which may indicate the amount of power in the magnetic signal 130 detected. The remote device 152 may also use an inertial measurement unit (IMU) module 166 to detect one or more characteristics of movement by the remote device 152. The IMU module 166, for example, may sense a rapid movement by the remote device 152 with an accelerometer 168 or similar sensor. Based on detecting the rapid movement (e.g., based on detecting that the velocity or acceleration of the movement achieves a threshold), the remote device 152 may utilize the communication module 162 to send an indication signal 132 to the local device 102 to indicate an occurrence of the rapid movement.

Based on receiving indication signal 132, the communication module 114 may send a reduction signal 134 to the remote device 152 indicating an impending reduction in the output power of the magnetic signal 130. Next, the transmitter 108 may decrease the output power of the magnetic signal 130 by decreasing its amplitude, frequency, and/or duty cycle using the magnetic signal modulator 110. When the magnetic signal 130 with reduced power reaches the remote device 152, the positioning module 172 may generate position data 136 based on the magnetic signal 130 with reduced power. Optionally, the positioning module 118 may determine the spatial position and orientation of the remote device 152 based on data, sent by the communication module 162, which may indicate the amount of power detected in the magnetic signal 130, as described further herein. The communication modules 114, 162 may also exchange communication data 138 such as calibration and timing signals.

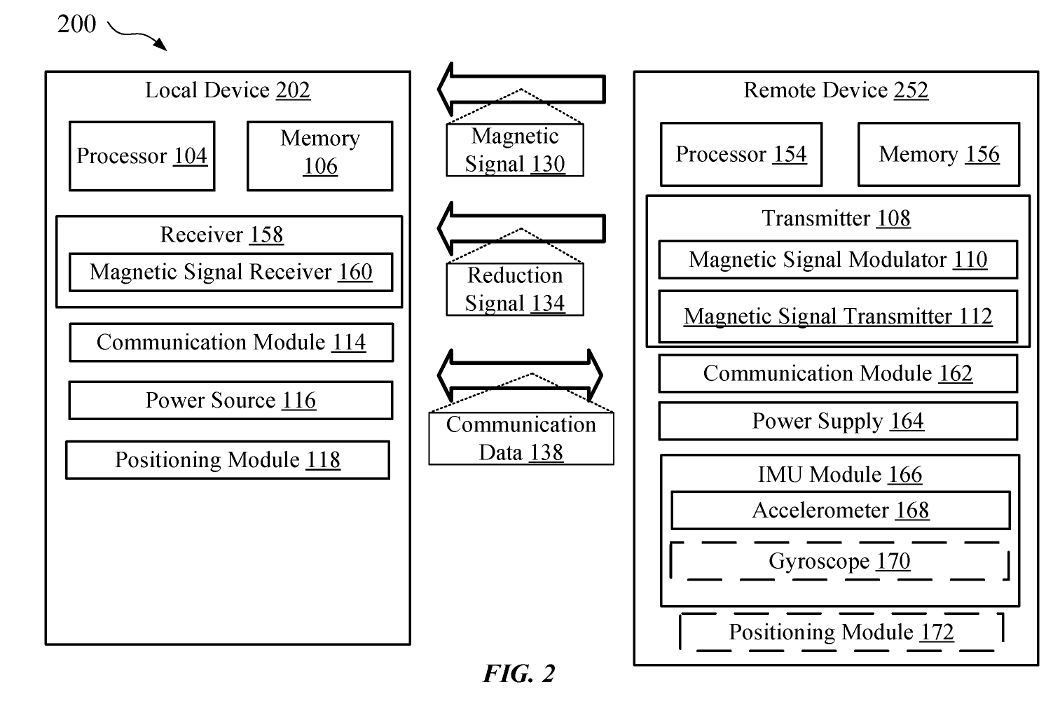

Referring now to FIG. 2, in certain implementations, another example of magnetic tracking system 200 may include a remote device 252 having the processor 154 and the memory 156 configured to instantiate the transmitter 108 for modulating and sending the magnetic signal 130 to a local device 202. The transmitter 208 includes the magnetic signal modulator 110 that modulates the amplitude, frequency, or duty cycle, etc., of the magnetic signal 130, and the magnetic signal transmitter 112 for transmitting the magnetic signal 130. The communication module 162 in the remote device 252 may send and/or receive signals to/from the local device 202. The remote device 252 includes a power supply 164 that provides electrical power to the components of the remote device 252. The power supply 164 may include a battery, an uninterrupted power supply, or a wall plug.

During operation, the transmitter 108 may send the magnetic signal 130, having an amplitude, frequency, and/or duty cycle, to the local device 202 with the processor 104 and the memory 106 configured to instantiate the receiver 158 to receive the magnetic signal 130. The receiver 158 of the local device 202 may use the magnetic signal receiver 160 to detect the magnetic signal 130 sent by the transmitter 108. By measuring an amount of electrical power in the detected magnetic signal 130, the local device 202 may generate data related to a spatial position and/or orientation of the remote device 252 with respect to the local device 202 using the positioning module 118. Optionally, the positioning module 172 may utilize information from the optional gyroscope 170 to generate an orientation data. The communication module 162 may send the orientation data generated by the positioning module 172 to the local device 202. The remote device 252 may also use the inertial measurement unit (IMU) module 166 to detect one or more characteristics of movement by the remote device 252. The IMU module 166 may sense a rapid movement of the remove device with the accelerometer 168 or similar sensor, as described.

Upon detecting the rapid movement, the remote device 252 may utilize the communication module 162 to send the reduction signal 134 to the local device 202 indicating an impending reduction in the output power of the magnetic signal 130. Based on the detected rapid movement and/or sending the reduction signal, the transmitter 108 may decrease the output power of the magnetic signal 130 by decreasing its amplitude, frequency, and/or duty cycle using the magnetic signal modulator 110. When the magnetic signal 130 with reduced power reaches the local device 202, the positioning module 118 may generate data related to the spatial position and/or orientation of the remote device 252 based on the magnetic signal 130 with reduced power. The communication modules 114, 162 may also exchange communication data 138 such as calibration and timing signals.

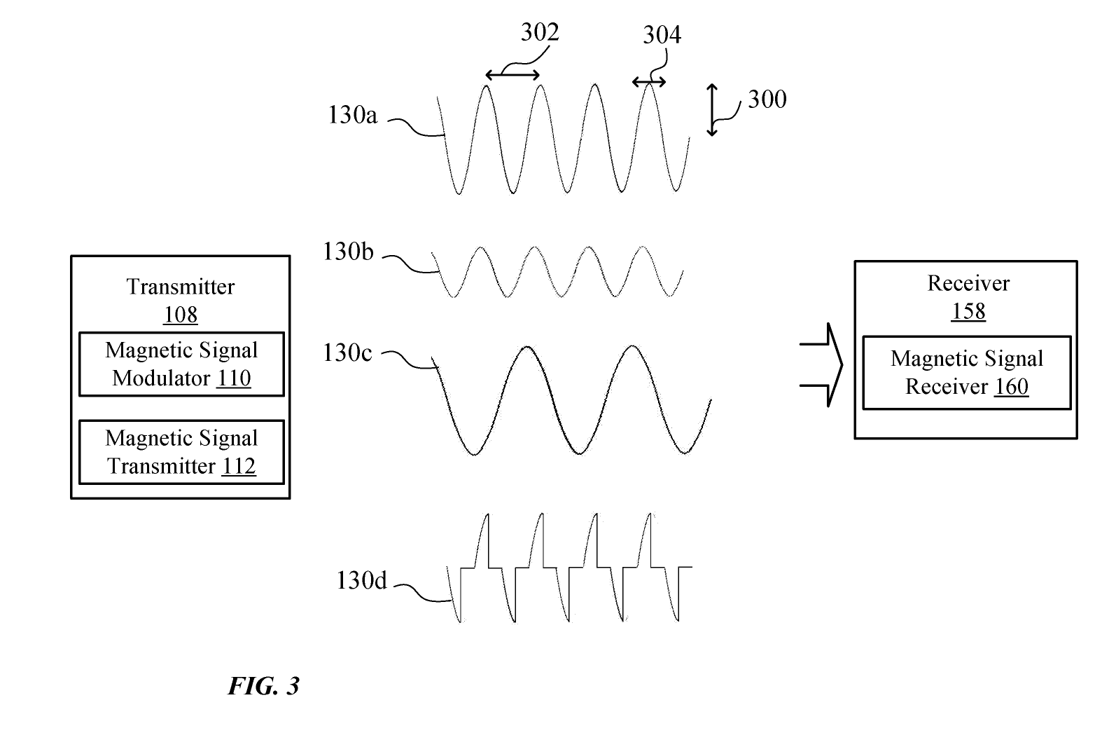

Referring to FIG. 3, in some implementations, the magnetic signal 130 sent by the transmitter 108 may be a magnetic signal 130a having an amplitude 300, frequency 302, and duty cycle 304 (expressed as the pulse width divided by the period). When the transmitter 108 reduces the power output of the magnetic signal 130a due to the detection of rapid movement, the magnetic signal modulator 110 may decrease the amplitude of the magnetic signal 130a to generate a magnetic signal 130b, decrease the frequency to generate a magnetic signal 130c, and/or decrease the duty cycle to generate a magnetic signal 130d. The magnetic signal modulator 110 may also reduce the power output of the magnetic signal 130a by changing any combination of amplitude, frequency, and duty cycle. While the non-limiting example in FIG. 3 illustrates a sinusoidal signal, the magnetic signal 130 may also be a saw-tooth signal, a square signal, a triangle signal, a pulse signal, or other suitable signals.

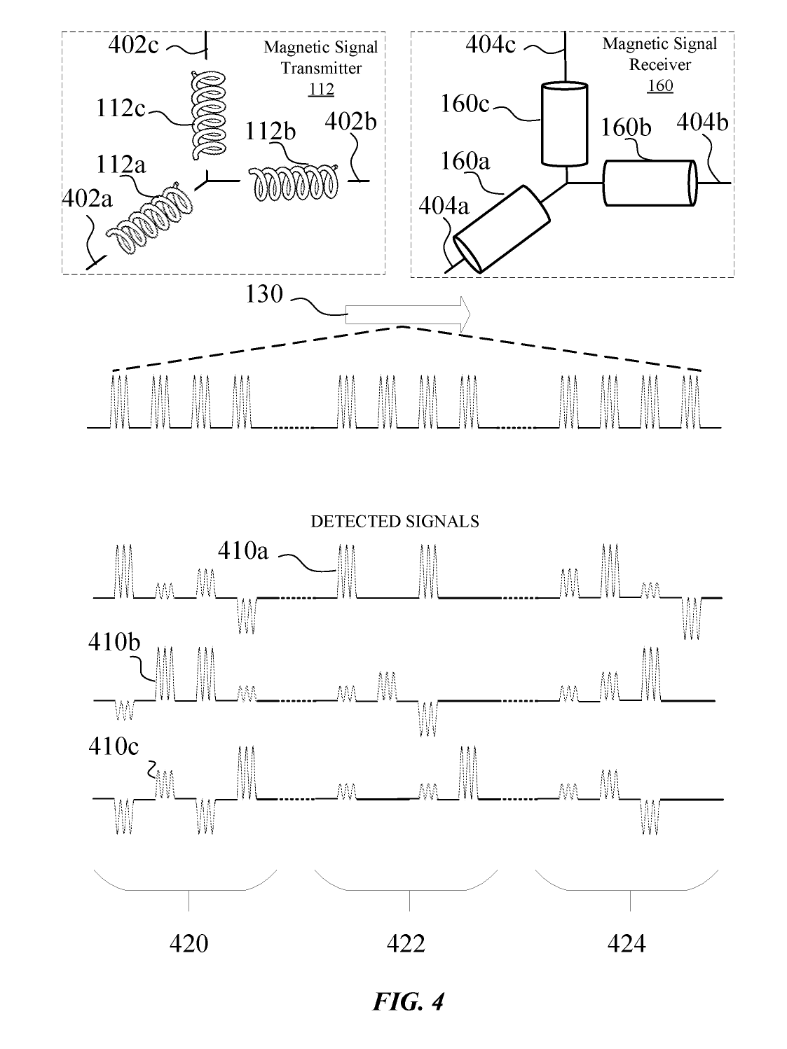

Referring to FIG. 4, in certain implementations, the magnetic signal transmitter 112 may include a first, second, and third solenoids 112a, 112b, 112c that generate electro-magnetic waves when electric currents pass through the wires of the solenoids. Each solenoid may include a magnetic core having one or more ferromagnetic material such as iron, cobalt, manganese, nickel, and other suitable element, compounds, or alloy. Specifically, the solenoids 112a-c may span a first axis 402a, a second axis 402b, and a third axis 402c. The first, second and third axes 402a-c may be orthogonal with respect to each other. The magnetic signal receiver 160 may include a first, second, and third detectors 160a, 160b, 160c that detect the magnetic signal 130 sent by the source solenoids 112a-c. The detectors 160a-c may span a first axis 404a, a second axis 404b, and a third axis 404c. The first, second and third axes 404a-c may be orthogonal with respect to each other. The solenoids 112a-c may transmit the magnetic signal 130a to the detectors 160a-c. Specifically, the first solenoid 112a may transmit the pulses in the magnetic signal 130a during a first period 420, the second solenoid 112b may transmit the pulses in the magnetic signal 130 during a second period 422, and the third solenoid 112c may transmit the pulses in the magnetic signal 130a during a third period 424. The first detector 160a may detect a first detected signal 410a. The second detector 160b may detect a second detected signal 410b. The third detector 160c may detect a third detected signal 410c.

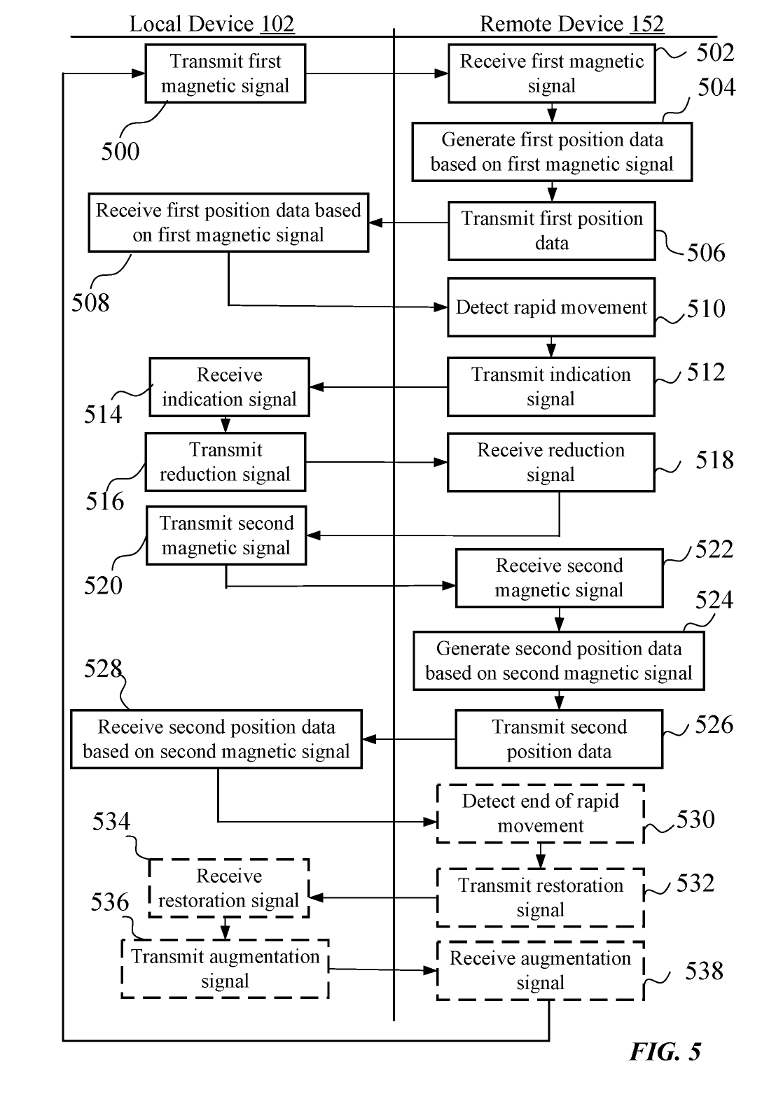

Referring now to FIG. 5, referencing FIGS. 1, 3, and 4, in certain examples, the local device 102 may transmit (500) a first magnetic signal to the remote device 152. For example, the magnetic signal transmitter 112 may transmit (500) the magnetic signal 130a for receipt by the magnetic signal receiver 160. Specifically, during operation, the local device 102 may first send a first timing signal, using the communication module 114, indicating the beginning of the first period 420. Next, the first solenoid 112a may send pulses of the magnetic signal 130a during the first period 420. The local device 102 can then send a second timing signal indicating the beginning of the second period, which is followed by the transmission of pulses of the magnetic signal 130a by the second solenoid 112b during the second period 422. The local device 102 can then send a third timing signal indicating the beginning of the third period. Next, the third solenoid 112c may send pulses of the magnetic signal 130a during the third period 424. The pulses sent by the first, second, and third solenoids 112a-c can be temporally separated so the remote device 152 may identify the source of the pulses (e.g. pulses in the first period 420 are sent by the first solenoid 112a, pulses in the second period 422 are sent by the second solenoid 112b, and pulses in the third period 424 are sent by the third solenoid 112c). The magnetic signal transmitter 112 may send the magnetic signal 130a at a frequency of 1 kilohertz, 2 kilohertz, 3 kilohertz, 5 kilohertz, 10 kilohertz, 20 kilohertz, 30 kilohertz, 50 kilohertz, 100 kilohertz, 200 kilohertz, 300 kilohertz, or 500 kilohertz. Other frequencies suitable for the application may be utilized.

In other examples, the magnetic signal transmitter 112 may generate electro-magnetic waves having three different characteristics (e.g. orientations, polarizations, frequencies, amplitudes . . . ) to differentiate the pulses sent by the three orthogonal solenoids 112a-c. For example, the first, second, and third solenoids 112a, 112b, 112c may send pulses of the magnetic signal 130a at a first, second, and third frequencies. Alternatively, the first, second, and third solenoids 112a, 112b, 112c may send pulses of the magnetic signal 130a at a first, second, and third polarizations.

Next, in some implementations, the remote device 152 may receive (502) the first magnetic signal sent by the local device 102. For example, the receiver 158 may sequentially receive (502) the first timing signal, the first, second, and third detected signals 410a-c during the first period 420, the second timing signal, the first, second, and third detected signals 410a-c during the second period 422, the third timing signal, and the first, second, and third detected signals 410a-c during the third period 424. In particular, the first detector 160a may detect the first detected signal 410a, the second detector 160b may detect the second detected signal 410b, and the third detector 160c may detect the third detected signal 410c. The detectors 160a-c may be energized by the magnetic signal 130a. Suitable detector configurations can include solenoids and other suitable inductive sensors. The detectors 160a-c may have sample rates of 2 kilohertz, 3 kilohertz, 5 kilohertz, 10 kilohertz, 20 kilohertz, 30 kilohertz, 50 kilohertz, 100 kilohertz, 200 kilohertz, 300 kilohertz, 500 kilohertz, or 1 megahertz. The detectors 160a-c may have sample rates satisfying the Nyquist condition of the pulse frequency of the magnetic signal 130a.

Next, in some examples, the remote device 152 may generate (504) a first position data based on the first magnetic signal received at the remote device 152. For example, the positioning module 172 may generate (504) the position data 136 based on the first, second, and third detected signals 410a-c. The position data 136, for example, may include a distance between the local device 102 and the remote device 152, an orientation of the remote device 152 (e.g., with respect to the local device 102), etc. The distance between the local device 102 and the remote device 152 may be calculated based on the amplitudes of the first, second, and third detected signals 410a-c, and an amplitude A_{T} of the magnetic signal 130a. If A₁, A₂, and A₃ is the amplitude of the first, second, and third detected signals 410a-c, respectively, the total received amplitude A_{R} of the first magnetic signal received at the remote device 152 may be calculated using the following equation:

A_{R}=\sqrt{A₁²+A₂²+A₃²}.

The amplitudes A_{T} and A_{R} are inversely related with respect to the distance between the local device 102 and the remote device 152. For example, as the distance between the local device 102 and the remote device 152 increases by 100%, the received amplitude A_{R} may decrease by 800%. A number of existing methods, including vector calculations, quaternion calculation, scalar calculations, may be used to derive the distance between the local device 102 and the remote device 152.

The orientation information may be computed from the differences in angle measurements between A̅_̅{̅R̅}̅, the vector spanned by the pulses in the first, second, and third detected signals 410a-c, and the axes 404a-c of the detectors 160a-c that detected the pulses of the magnetic signal 130a. For example, during the first period 420, the first, second, and third detectors 160a-c may detect pulses sent by the first solenoid 112a as the first, second, and third detected signals 410a-c. Therefore, the angle θ between \vec{A_{R}} and the first axis 404a may be calculated using the following equation:

$$θ = {cos}^{- 1} \frac{{A}_{1}}{{A}_{R}} .$$

The angle ρ between A̅_̅{̅R̅}̅ and the second axis 404b may be computed by the following equation:

$$ρ = {cos}^{- 1} \frac{{A}_{2}}{{A}_{R}} .$$

The angle φ between A̅_̅{̅R̅}̅ and the third axis 404c may be computed by the following equation:

$$ϕ = {cos}^{- 1} \frac{{A}_{3}}{{A}_{R}} .$$

In summary, the amplitude (A_{R}) of the vector A̅_̅{̅R̅}̅ may indicate the distance between the local device 102 and the remote device 152, and the angle measurements between the vector A̅_̅{̅R̅}̅ and the axes 404a-c may indicate the orientation of the remote device 152 with respect to the local device 102. In some implementations, the positioning module 172 may use data from the gyroscope 170 to generate a portion of the position data 136.

In the next step, the remote device 152 may transmit (506) the first position data. For example, the communication module 162 may send the position data 136, which can indicate a position of the remote device 152 with respect to the local device 102 and/or may include the distance and/or orientation of the remote device 152 with respect to the local device 102, to the communication module 114 of the local device 102. The communication module 162 may communicate with the communication module 114 via radio wave, Wi-Fi, Bluetooth, near-field communication (NFC), or any suitable wired and wireless communication technology. In another example, the communication module 162 may transmit (506) the numerical data representing the first, second, and third detected signals 410a-c to the communication module 114 of the local device 102. In some examples, the communication module 114 may transmit cyclic redundancy check bits with the position data 136 or the numerical data representing the first, second, and third detected signals 410a-c.

Next, the local device 102 may receive (508) the first position data sent by the remote device 152. For example, the communication module 114 of the local device 102 may receive (508) the position data 136 sent by the communication module 162 of the remote device 152. In other examples, the communication module 114 may receive numerical data representing the first, second, and third detected signals 410a-c. The positioning module 118 of the local device 102 may use the numerical data to calculate the position data 136 as indicated above. The communication modules 114, 162 may communicate via radio wave, Wi-Fi, Bluetooth, near-field communication (NFC), or any suitable wired and wireless communication technology. Optionally, the local device 102 may verify the accuracy of the position data 136 using the cyclic redundancy check bits.

In some implementations, the remote device 152 may detect (510) a rapid movement (e.g., of the remote device 152). For example, the IMU module 166 may detect (510) the rapid movement of the remote device 152 using the accelerometer 168 or other sensor to detect that a velocity or acceleration corresponding to the movement of the remote device 152 achieves a threshold. An example rapid movement may include the remote device 152 moving at a rate of 10 centimeter/second, 20 centimeter/second, 50 centimeter/second, 100 centimeter/second, 150 centimeter/second, 200 centimeter/second, and/or the like, which can be detected based on input from the accelerometer 168 or similar sensor. Other rate of movement may also be considered a rapid movement by the IMU module 166. Alternatively, IMU module 166 may detect (510) the rapid movement using the positioning module 172 to identify a rapid change in the amplitude A_{R} of vector A̅_̅{̅R̅}̅ (e.g., a change achieving a threshold).

Based on the detection of the rapid movement, the remote device 152 may transmit (512) an indication signal to the local device 102 to indicate the rapid movement of the remote device 152 (e.g., that the velocity or acceleration of the movement achieves a threshold). For example, the communication module 162 may transmit (512) the indication signal 132 to the communication module 114 to inform the local device 102 of the detection of the rapid movement. The indication signal may be generated by the IMU module 166 when the accelerometer 168 detects the remote device 152 engaging in a rapid movement.

In the next step, in some examples, the local device 102 may receive (514) the indication signal that signifies the detection of the rapid movement by the remote device 152. For example, the communication module 114 may receive (514) the indication signal 132 from the communication module 162.

In certain implementations, after the reception of the indication module, the local device 102 may transmit (516) a reduction signal to the remote device 152. For example, the communication module 114 may transmit (516) the reduction signal 134 to the communication module 162. The communication module 114 may generate the reduction signal 134 in response to the reception of the indication signal 132.

Next, in certain examples, the remote device 152 may receive (518) the reduction signal. For example, the communication module 162 of the remote device 152 may receive (518) the reduction signal 134 sent by the communication module 114. The reduction signal 134 may indicate to the remote device 152 that the local device 102 may subsequently send another magnetic signal with diminished power output.

In some implementations, the local device 102 may transmit (520) a second magnetic signal. For example, the magnetic signal transmitter 112 may transmit (520) one of the magnetic signals 130b-d, such as the magnetic signal 130b, to the magnetic signal receiver 160. The magnetic signals 130b-d may consume less electrical power than the magnetic signal 130a. For example, to lower the electrical power consumption, the magnetic signal modulator 110 may modify the amplitude 300, frequency 302, or duty cycle 304 of the magnetic signal 130a to generate the magnetic signals 130b, 130c, 130d, respectively, prior to transmission. In other examples, the transmitter 108 may transmit (520) other magnetic signals that require less power than the magnetic signal 130a.

Following the transmission of the second magnetic signal, in certain examples, the remote device 152 may receive (522) the second magnetic signal. For example, the magnetic signal receiver 160 may receive (522) the one of the magnetic signals 130b-d, such as the magnetic signal 130b, sent by the magnetic signal transmitter 112.

Based on the received second magnetic signal, the remote device 152 may generate (524) a second position data based on the second magnetic signal. For example, the positioning module 172 may generate (524) the position data 136 based on the first, second, and third detected signals 410a-c as described above. For the determination step, the positioning module 172 may determine the distance and orientation of the remote device 152 based on the magnetic signal with reduced power, such as the magnetic signal 130b.

Next, the remote device 152 may transmit (526) the second position data. For example, the communication module 162 may send the position data 136, which can indicate a second position of the remote device 152 with respect to the local device 102, and may include the distance and/or orientation of the remote device 152 with respect to the local device 102, to the communication module 114 of the local device 102. In another example, the communication module 162 may transmit (526) the numerical data representing the first, second, and third detected signals 410a-c to the communication module 114 of the local device 102.

Next, the local device 102 may receive (528) the second position data sent by the remote device 152. For example, the communication module 114 of the local device 102 may receive (528) the position data 136 sent by the communication module 162 of the remote device 152. In other examples, the communication module 114 may receive numerical data representing the first, second, and third detected signals 410a-c. The positioning module 118 of the local device 102 may use the numerical data to calculate the position data 136 as indicated above. In one example, the local device 102 may continue to transmit the second magnetic signal 520 at least until an indication of an end of the rapid movement is received.

In some implementations, the remote device 152 may optionally detect (530) an end of the rapid movement. For example, the IMU module 166 may detect (530) the end of the rapid movement of the remote device 152 using the accelerometer 168 or other sensor (e.g., based on detecting that a velocity or acceleration of the remote device 152 no longer achieves the threshold, achieves or does not achieve a second lower or higher threshold, etc.). Alternatively, IMU module 166 may detect (530) the end of the rapid movement using the positioning module 172 to identify a rapid change in the amplitude A_{R} of vector A̅_̅{̅R̅}̅.

Next, the remote device 152 may optionally transmit (532) a restoration signal to the local device 102. For example, the communication module 162 may transmit (532) the restoration signal to the communication module 114 to inform the local device 102 of the end of the rapid movement. The indication signal may be generated by the IMU module 166 when the accelerometer 168 detects the remote device 152 ending the rapid movement.

In the next step, in some examples, the local device 102 may optionally receive (534) the restoration signal that signifies the detection of the rapid movement by the remote device 152. For example, the communication module 114 may receive (534) the restoration signal from the communication module 162.

In certain implementations, after the reception of the indication module, the local device 102 may optionally transmit (536) an augmentation signal to the remote device 152. For example, the communication module 114 may transmit (536) the augmentation signal to the communication module 162. The communication module 114 may generate the augmentation signal in response to the reception of the restoration signal.

Next, in certain examples, the remote device 152 may optionally receive (538) the augmentation signal. For example, the communication module 162 of the remote device 152 may receive (538) the augmentation signal sent by the communication module 162. The augmentation signal may indicate to the remote device 152 that the local device 102 may subsequently send another magnetic signal with increased power output.

In some implementations, the local device 102 may resume transmitting (500) the first magnetic signal. For example, the magnetic signal transmitter 112 may transmit (500) the magnetic signal 130a, to the magnetic signal receiver 160. In other examples, the transmitter 108 may transmit (500) other magnetic signals that require more power than the magnetic signals 130b-d.

In some examples, the remote device 152 may periodically or continuously send the indication signal 132 during the detection of the rapid movement. In response to the periodic or continuous stream of indication signals 132, the local device 102 may transmit the second magnetic signal, for example, the magnetic signal 130b. Once the rapid movement seizes (e.g., once the movement is no longer detected as achieving the corresponding velocity or acceleration threshold(s)), the remote device 152 can terminate the transmission of the indication signal, and the local device 102 can correspondingly resume the transmission of the first magnetic signal, for example, the magnetic signal 130a.

In some examples, the first magnetic signal and the second magnetic signal received at the remote device 152 may charge a battery in the power supply 164.

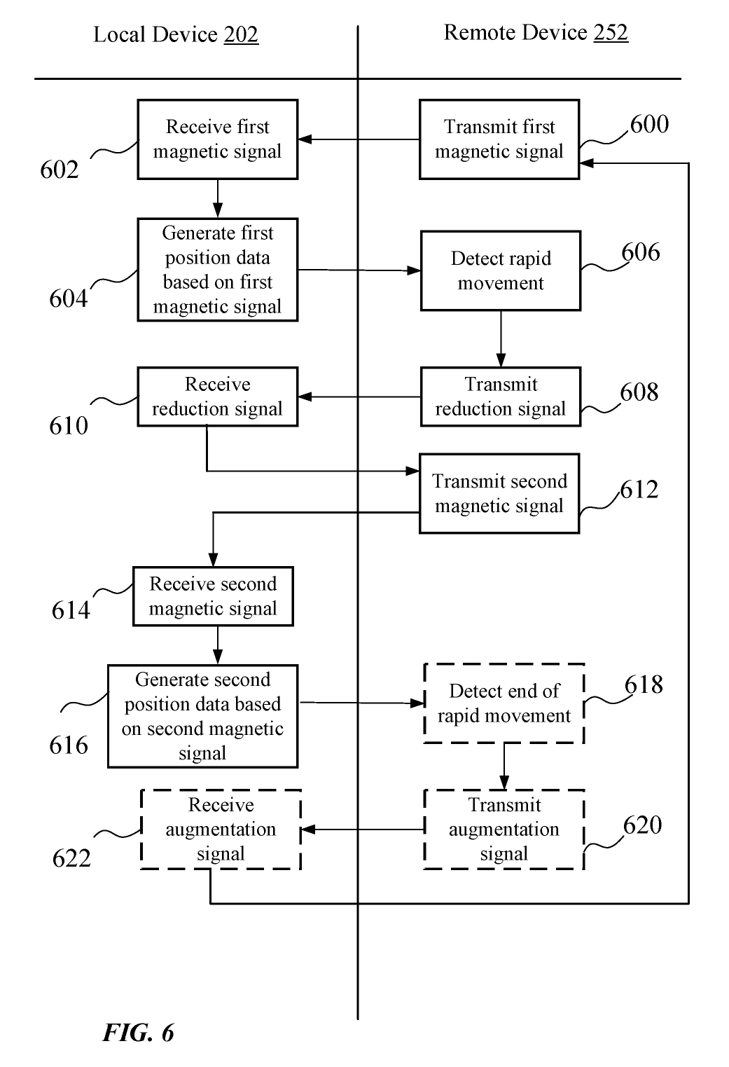

Referring now to FIG. 6, referencing FIGS. 2, 3, and 4, in certain examples, the remote device 252 may transmit (600) the first magnetic signal to the local device 102. For example, the magnetic signal transmitter 112 may transmit (600) the magnetic signal 130a to the magnetic signal receiver 160, as described above.

Next, in some implementations, the local device 202 may receive (602) the first magnetic signal sent by the local device 202. For example, the receiver 158 may sequentially receive (602) the first timing signal, the first, second, and third detected signals 410a-c during the first period 420, the second timing signal, the first, second, and third detected signals 410a-c during the second period 422, the third timing signal, and the first, second, and third detected signals 410a-c during the third period 424.

Next, in some examples, the local device 202 may generate (604) the first position data based on the first magnetic signal received at the local device 202. For example, the positioning module 118 may generate (604) the position data 136 based on the first, second, and third detected signals 410a-c according to the methods described above.

In some implementations, the remote device 252 may detect (606) the rapid movement. For example, the IMU module 166 may detect (606) the rapid movement of the remote device 252 using the accelerometer 168. Alternatively, IMU module 166 may detect (606) the rapid movement using the positioning module 172 to identify a rapid change in the amplitude A_{R} of vector A̅_̅{̅R̅}̅.

After the detection of the rapid movement, the remote device 252 may transmit (608) the reduction signal to the local device 202. For example, the communication module 162 may transmit (608) the reduction signal 134 to the communication module 114. The communication module 162 may generate the reduction signal 134 in response to the detection of the rapid movement.

Next, in certain examples, the local device 202 may receive (610) the reduction signal. For example, the communication module 114 of the local device 202 may receive (610) the reduction signal 134 sent by the communication module 162. The reduction signal 134 may indicate to the local device 202 that the remote device 152 may subsequently send another magnetic signal with diminished power output.

In some implementations, the remote device 252 may transmit (612) the second magnetic signal. For example, the magnetic signal transmitter 112 may transmit (612) the one of the magnetic signals 130b-d, such as the magnetic signal 130b, to the magnetic signal receiver 160.

Following the transmission of the second magnetic signal, in certain examples, the local device 202 may receive (614) the second magnetic signal. For example, the magnetic signal receiver 160 may receive (614) the one of the magnetic signals 130b-d, such as the magnetic signal 130b, sent by the magnetic signal transmitter 112.

Based on the received second magnetic signal, the local device 202 may generate (616) the second position data based on the second magnetic signal. For example, the positioning module 118 may generate (616) the position data 136 based on the first, second, and third detected signals 410a-c as described above.

In optional implementations, the remote device 252 may detect (618) the end of the rapid movement. For example, the IMU module 166 may detect (618) the end of the rapid movement of the remote device 252 using the accelerometer 168. Alternatively, IMU module 166 may detect (618) the end of the rapid movement using the positioning module 172 to identify a rapid change in the amplitude A_{R} of vector A̅_̅{̅R̅}̅.

After the detection of the end of the rapid movement, the remote device 252 may optionally transmit (620) the augmentation signal to the local device 202. For example, the communication module 162 may transmit (620) the augmentation signal to the communication module 114. The communication module 162 may generate the augmentation signal in response to the detection of the end of the rapid movement.

Next, in certain examples, the local device 202 may optionally receive (622) the restoration signal. For example, the communication module 114 of the local device 202 may receive (622) the augmentation signal sent by the communication module 162. The augmentation signal may indicate to the local device 202 that the remote device 152 may subsequently send another magnetic signal with higher power output.

In some implementations, the remote device 252 may resume transmitting (600) the first magnetic signal. For example, the magnetic signal transmitter 112 may transmit (600) the magnetic signal 130a to the magnetic signal receiver 160.

In some examples, the remote device 252 may periodically or continuously send the reduction signal 134 during the detection of the rapid movement. Further, the remote device 252 may transmit the second magnetic signal, such as the magnetic signal 130b. Once the rapid movement stops, the remote device 152 terminates the transmission of the reduction signal 134, and resumes the transmission of the first magnetic signal, such as the magnetic signal 130a.

In some examples, the first magnetic signal and the second magnetic signal received at the local device 22 may charge a battery in the power supply 116.

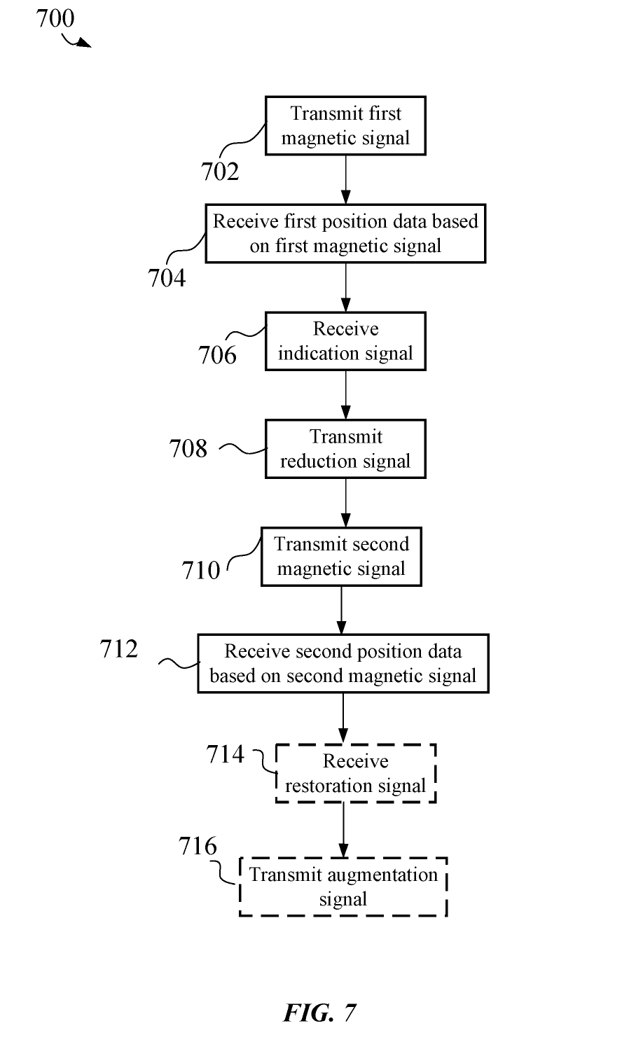

Turning now to FIG. 7, an example of a method 700 for transmitting reduced magnetic signals by the local device 102 is illustrated. In some implementations, the local device 102 may transmit (702) a first magnetic signal to the remote device 152. In an example, the magnetic signal transmitter 112, e.g. in conjunction with the processor 104, the memory 106, the transmitter 108, etc., may transmit (702) the first magnetic signal to the remote device 152. For example, the magnetic signal transmitter 112 may transmit the first magnetic signal at a first power (e.g., amplitude frequency, duty cycle, etc.), which may correspond to a first power state.

In some implementations, the local device 102 may receive (704) a first position data from the remote device 152 based on the first magnetic signal, wherein the first position data indicates a first position of the remote device 152 relative to the local device 102. In an example, the communication module 114, e.g. in conjunction with the processor 104, the memory 106, etc., may receive (704) the first position data from the remote device 152. For example, the communication module 114 may receive numerical data representing the first, second, and third detected signals 410a-c. The positioning module 118 of the local device 102 may use the numerical data to calculate the position data 136 as indicated above.

In some implementations, the local device 102 may receive (706) an indication signal indicating a rapid movement, wherein the rapid movement includes a velocity or an acceleration of the remote device 152 achieving a threshold. In an example, the communication module 114, e.g. in conjunction with the processor 104, the memory 106, etc., may receive (706) the indication signal indicating that a velocity or acceleration corresponding to the movement of the remote device 152 achieves a threshold.

In some implementations, the local device 102 may transmit (708) a reduction signal indicating an impending reduction in a first power of the first magnetic signal in response to receiving the indication signal. In an example, the communication module 114, e.g. in conjunction with the processor 104, the memory 106, etc., may transmit (708) the reduction signal.

In some implementations, the local device 102 may transmit (710) a second magnetic signal based on transmitting the reduction signal, wherein the second magnetic signal has a second power lower than the first power. In an example, the magnetic signal transmitter 112, e.g. in conjunction with the processor 104, the memory 106, the transmitter 108, etc., may transmit the first magnetic signal to the remote device 152. For example, the magnetic signal transmitter 112 may transmit (710) the first magnetic signal at the second power (e.g., amplitude frequency, duty cycle, etc.), which may correspond to a second power state.

In some implementations, the local device 102 may receive (712) a second position data from the remote device 152 based on the second magnetic signal, wherein the second position data indicates a second position of the remote device 152 relative to the local device 102. In an example, the communication module 114, e.g. in conjunction with the processor 104, the memory 106, etc., may receive (712) the second position data from the remote device 152. In other examples, the communication module 114 may receive numerical data representing the first, second, and third detected signals 410a-c.

In some implementations, the local device 102 may optionally receive (714) a restoration signal. In an example, the communication module 114, e.g. in conjunction with the processor 104, the memory 106, etc., may optionally receive (714) a restoration signal.

In some implementations, the local device 102 may optionally transmit (716) an augmentation signal indicating an impending increase in the second power of the second magnetic signal in response to receiving the restoration signal. In an example, the communication module 114, e.g. in conjunction with the processor 104, the memory 106, etc., may optionally transmit (716) an augmentation signal.

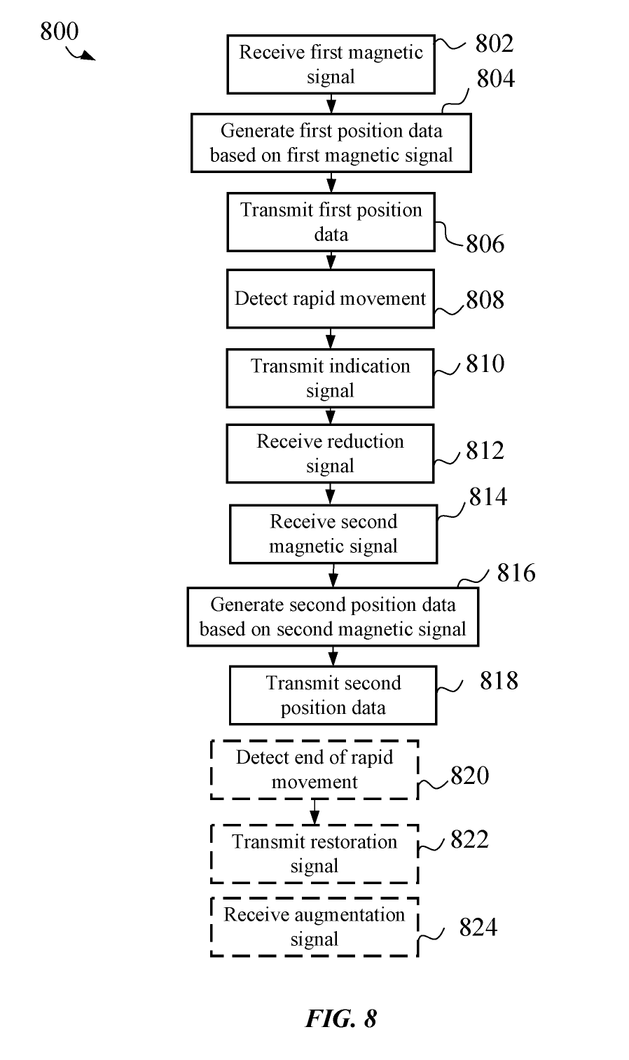

Turning now to FIG. 8, an example of a method 800 for receiving reduced magnetic signals by the remote device 152 is illustrated. In certain implementations, the remote device 152 may receive (802) a first magnetic signal having a first power from the local device 102. In an example, the magnetic signal receiver 160, e.g. in conjunction with the processor 154, the memory 156, the receiver 158, etc., may receive (802) the first magnetic signal from the local device 102. For example, the remote device 152 may sequentially receive (802) the first timing signal, the first, second, and third detected signals 410a-c during the first period 420, the second timing signal, the first, second, and third detected signals 410a-c during the second period 422, the third timing signal, and the first, second, and third detected signals 410a-c during the third period 424. In particular, the first detector 160a may detect the first detected signal 410a, the second detector 160b may detect the second detected signal 410b, and the third detector 160c may detect the third detected signal 410c. The detectors 160a-c may be energized by the magnetic signal 130a.

In certain implementations, the remote device 152 may generate (804) a first position data based on the first magnetic signal. For example, the positioning module 172, e.g. in conjunction with the processor 154, the memory 156, e.g., may generate (804) the position data 136 based on the first, second, and third detected signals 410a-c. The position data 136, for example, may include a distance between the local device 102 and the remote device 152, an orientation of the remote device 152 (e.g., with respect to the local device 102), etc.

In certain implementations, the remote device 152 may transmit (806) the first position data to the local device 102. For example, the communication module 162, e.g. in conjunction with the processor 154, the memory 156, e.g., may transmit (806) the position data 136, which can indicate a position of the remote device 152 with respect to the local device 102 and/or may include the distance and/or orientation of the remote device 152 with respect to the local device 102, to the communication module 114 of the local device 102.

In certain implementations, the remote device 152 may detect (808) a rapid movement, wherein the rapid movement includes a velocity or an acceleration of the remote device 152 achieving a threshold. For example, the IMU module 166, e.g. in conjunction with the processor 154, the memory 156, the accelerometer 168, the gyroscope 170 e.g., may detect (808) the rapid movement of the remote device 152 using the accelerometer 168 or other sensor to detect that a velocity or acceleration corresponding to the movement of the remote device 152 achieves a threshold.

In certain implementations, the remote device 152 may transmit (810) an indication signal indicating a detection of the rapid movement to the local device 102. For example, the communication module 162, e.g. in conjunction with the processor 154, the memory 156, e.g., may transmit (810) the indication signal 132 to the communication module 114 to inform the local device 102 of the detection of the rapid movement.

In certain implementations, the remote device 152 may receive (812) a reduction signal indicating an impending reduction in the first power of the first magnetic signal. For example, the communication module 162, e.g. in conjunction with the processor 154, the memory 156, e.g., of the remote device 152 may receive (812) the reduction signal 134 sent by the communication module 114. The reduction signal 134 may indicate to the remote device 152 that the local device 102 may subsequently send another magnetic signal with diminished power output.

In certain implementations, the remote device 152 may receive (814) a second magnetic signal, wherein the second magnetic signal has a second power lower than the first power. In an example, the magnetic signal receiver 160, e.g. in conjunction with the processor 154, the memory 156, the receiver 158, etc., may receive (812) the one of the magnetic signals 130b-d, such as the magnetic signal 130b, sent by the magnetic signal transmitter 112.

In certain implementations, the remote device 152 may generate (816) a second position data based on the second magnetic signal. For example, the positioning module 172, e.g. in conjunction with the processor 154, the memory 156, e.g., may generate (816) the position data 136 based on the first, second, and third detected signals 410a-c. The position data 136, for example, may include a distance between the local device 102 and the remote device 152, an orientation of the remote device 152 (e.g., with respect to the local device 102), etc.

In certain implementations, the remote device 152 may transmit (818) the second position data to the local device 102. For example, the communication module 162, e.g. in conjunction with the processor 154, the memory 156, e.g., may transmit (818) the position data 136, which can indicate a second position of the remote device 152 with respect to the local device 102, and may include the distance and/or orientation of the remote device 152 with respect to the local device 102, to the communication module 114 of the local device 102.

In certain implementations, the remote device 152 may optionally detect (820) an end of the rapid movement. For example, the IMU module 166, e.g. in conjunction with the processor 154, the memory 156, the accelerometer 168, the gyroscope 170 e.g., may detect (820) the end of the rapid movement of the remote device 152 using the accelerometer 168 or other sensor (e.g., based on detecting that a velocity or acceleration of the remote device 152 no longer achieves the threshold, achieves or does not achieve a second lower or higher threshold, etc.). Alternatively, IMU module 166 may detect (820) the end of the rapid movement using the positioning module 172 to identify a rapid change in the amplitude A_{R} of vector A̅_̅{̅R̅}̅.

In certain implementations, the remote device 152 may transmit (822) a restoration signal in response to detecting the end of the rapid movement to the local device 102. For example, the communication module 162, e.g. in conjunction with the processor 154, the memory 156, e.g., may transmit (822) the restoration signal to the communication module 114 to inform the local device 102 of the end of the rapid movement.

In certain implementations, the remote device 152 may receive (824) an augmentation signal indicating an impending increase in the second power of the second magnetic signal. For example, the communication module 162, e.g. in conjunction with the processor 154, the memory 156, e.g., may transmit (532) the restoration signal to the communication module 114 to inform the local device 102 of the end of the rapid movement.

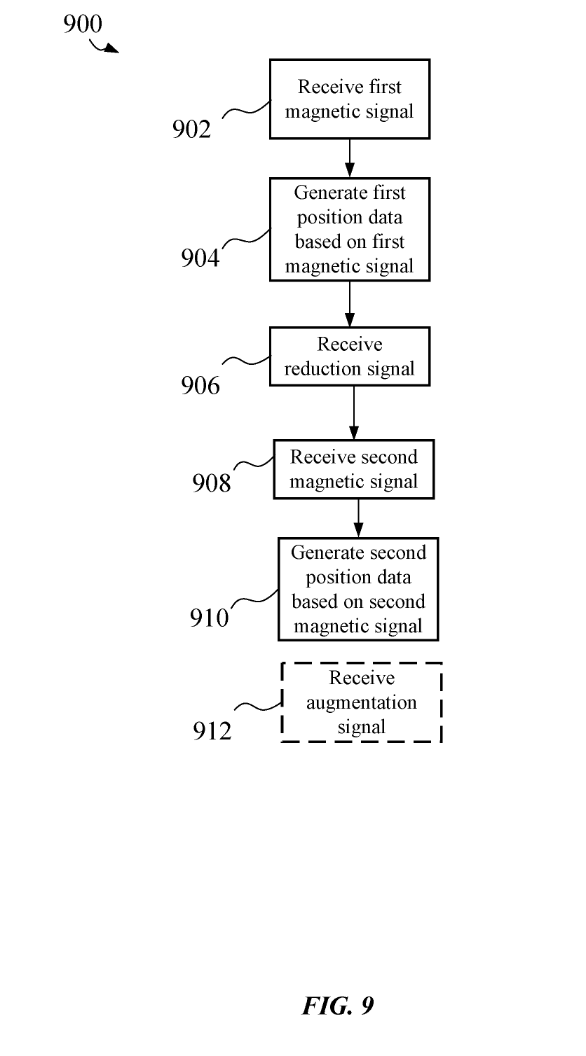

Turning now to FIG. 9, an example of a method 900 for receiving reduced magnetic signals by the local device 202 is illustrated. In certain implementations, the local device 202 may receive (902) a first magnetic signal having a first power from the remote device 252. For example, the magnetic signal receiver 160, e.g. in conjunction with the processor 154, the memory 156, the receiver 158, e.g., may sequentially receive (902) the first timing signal, the first, second, and third detected signals 410a-c during the first period 420, the second timing signal, the first, second, and third detected signals 410a-c during the second period 422, the third timing signal, and the first, second, and third detected signals 410a-c during the third period 424.

In certain implementations, the local device 202 may generate (904) a first position data based on the first magnetic signal. For example, the positioning module 118, e.g. in conjunction with the processor 154, the memory 156, e.g., may generate (604) the position data 136 based on the first, second, and third detected signals 410a-c according to the methods described above.

In certain implementations, the local device 202 may receive (906) a reduction signal indicating an impending reduction in the first power of the first magnetic signal. For example, the communication module 114 of the local device 202, e.g. in conjunction with the processor 154, the memory 156, e.g., may receive (906) the reduction signal 134 sent by the communication module 162.

In certain implementations, the local device 202 may receive (908) a second magnetic signal, wherein the second magnetic signal has a second power lower than the first power of the first magnetic signal. For example, the magnetic signal receiver 160, e.g. in conjunction with the processor 154, the memory 156, the receiver 158, e.g., may receive (908) the one of the magnetic signals 130b-d, such as the magnetic signal 130b, sent by the magnetic signal transmitter 112.

In certain implementations, the local device 202 may generate (910) a second position data based on the second magnetic signal, wherein the second position data indicates a second distance and a second orientation of the remote device 252 relative to the local device 202. For example, the positioning module 118, e.g. in conjunction with the processor 154, the memory 156, may generate (910) the position data 136 based on the first, second, and third detected signals 410a-c as described above.

In certain implementations, the local device 202 may optionally receive (912) an augmentation signal indicating an impending increase in the second power of the second magnetic signal. For example, the communication module 114 of the local device 202, e.g. in conjunction with the processor 154, the memory 156, may receive (912) the augmentation signal sent by the communication module 162.

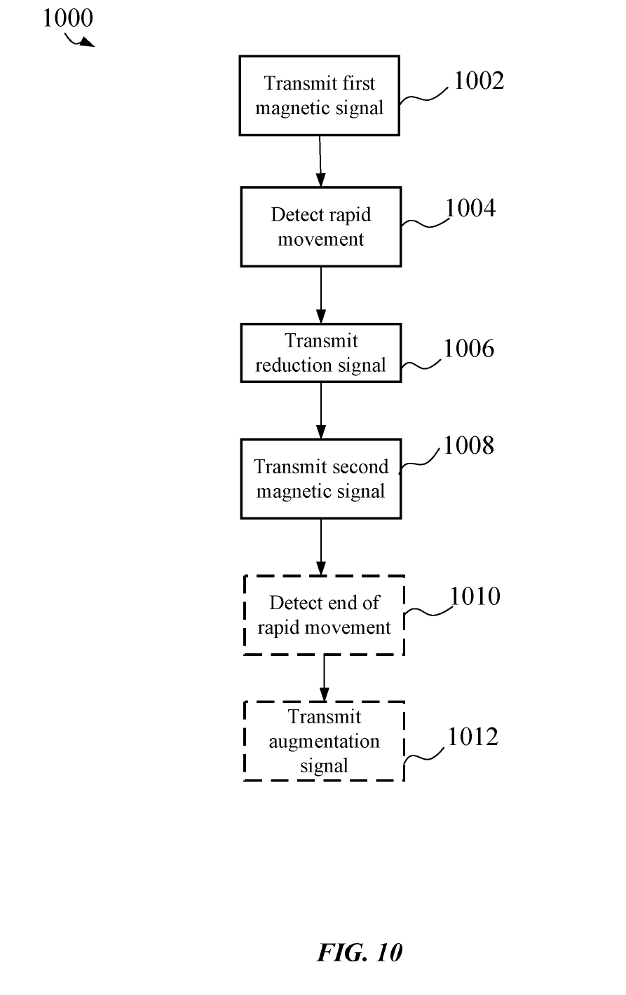

Turning now to FIG. 10, an example of a method 1000 for transmitting reduced magnetic signals by the remote device 252 is illustrated. In some implementations, the remote device 252 may transmit (1002) a first magnetic signal having a first power to the local device 202. In an example, the magnetic signal transmitter 112, e.g. in conjunction with the processor 154, the memory 156, the transmitter 108, etc., may transmit (1002) the first magnetic signal to the local device 202. In another example, the magnetic signal transmitter 112 may transmit the first magnetic signal at a first power (e.g., amplitude frequency, duty cycle, etc.), which may correspond to a first power state.

In some implementations, the remote device 252 may detect (1004) a rapid movement at the remote device 252, wherein the rapid movement includes a velocity or an acceleration of the remote device achieving a threshold. For example, the IMU module 166, e.g. in conjunction with the processor 154, the memory 156, the accelerometer 168, the gyroscope 170, etc., may detect (1004) the rapid movement of the remote device 252 using the accelerometer 168. Alternatively, IMU module 166 may detect (606) the rapid movement using the positioning module 172 to identify a rapid change in the amplitude A_{R} of vector A̅_̅{̅R̅}̅.

In some implementations, the remote device 252 may transmit (1006) a reduction signal indicating an impending decrease in the first power of the first magnetic signal. For example, the communication module 162, e.g. in conjunction with the processor 154, the memory 156, etc., may transmit (1006) the reduction signal 134 to the communication module 114.

In some implementations, the remote device 252 may transmit (1008) a second magnetic signal having a second power, wherein the second power is lower than the first power. For example, the magnetic signal transmitter 112, e.g. in conjunction with the processor 154, the memory 156, the transmitter 108, etc., may transmit (1008) the one of the magnetic signals 130b-d, such as the magnetic signal 130b, to the magnetic signal receiver 160. The magnetic signal transmitter 112 may transmit the second magnetic signal at a second power (e.g., amplitude frequency, duty cycle, etc.), which may correspond to a second power state.

In some implementations, the remote device 252 may optionally detect (1010) an end of the rapid movement. For example, the IMU module 166, e.g. in conjunction with the processor 154, the memory 156, the accelerometer 168, the gyroscope 170, etc., may detect (1010) the end of the rapid movement of the remote device 252 using the accelerometer 168. Alternatively, the IMU module 166 may detect (1010) the end of the rapid movement using the positioning module 172 to identify a rapid change in the amplitude A_{R} of vector A̅_̅{̅R̅}̅.

In some implementations, the remote device 252 may transmit (1012) an augmentation signal indicating an impending increase in the second power of the second magnetic signal. For example, the communication module 162, e.g. in conjunction with the processor 154, the memory 156, etc., may transmit (1012) the augmentation signal to the communication module 114.

As used in this application, the terms “device,” “component,” “system,” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various examples are described herein in connection with a device, which can be a wired device or a wireless device. A wireless device may be a computer, a gaming device, cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Further, a wired device may include a server operable in a data centers (e.g., cloud computing).

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various examples described herein. Various modifications to these examples will be readily apparent to those skilled in the art, and the generic principles defined herein may be applied to other examples. Thus, the claims are not intended to be limited to the examples shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any example described herein as “exemplary” is not necessarily to be construed as preferred or advantageous over other examples. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various examples described throughout this application that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It should be appreciated to those of ordinary skill that various examples or features are presented in terms of systems that may include a number of devices, components, modules, and the like. It is to be understood and appreciated that the various systems may include additional devices, components, modules, etc., and/or may not include all of the devices, components, modules etc. discussed in connection with the figures.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof specially-designed to perform the functions described herein. A specially programmed general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some examples, the processor and the storage medium may reside in an ASIC. Additionally, the ASIC may reside in transmitter 108. In the alternative, the processor and the storage medium may reside as discrete components in transmitter 108. Additionally, in some examples, the steps and/or actions of a method or algorithm may reside as one or any combination or set of codes and/or instructions on a machine readable medium and/or computer readable medium, which may be incorporated into a computer program product.

In one or more examples, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While examples of the present application have been described in connection with examples thereof, it will be understood by those skilled in the art that variations and modifications of the examples described above may be made without departing from the scope hereof. Other examples will be apparent to those skilled in the art from a consideration of the specification or from a practice in accordance with examples disclosed herein.

What is claimed is:

1. A method of sending reduced power signals using a local device, comprising:
transmitting a first magnetic signal to a remote device;
receiving a first position data from the remote device based on the first magnetic signal, wherein the first position data indicates a first position of the remote device relative to the local device;
receiving an indication signal indicating a rapid movement, wherein the rapid movement includes a velocity or an acceleration of the remote device achieving a threshold;
transmitting a reduction signal indicating a reduction in a first power of the first magnetic signal in response to receiving the indication signal;
transmitting a second magnetic signal based on transmitting the reduction signal, wherein the second magnetic signal has a second power lower than the first power; and
receiving a second position data from the remote device based on the second magnetic signal, wherein the second position data indicates a second position of the remote device relative to the local device.

2. The method of claim 1, further comprising:
receiving a restoration signal;
transmitting an augmentation signal indicating an increase in the second power of the second magnetic signal in response to receiving the restoration signal;
transmitting the first magnetic signal at the first power based on transmitting the augmentation signal; and
receiving a third position data from the remote device based on the first magnetic signal, wherein the third position data indicates a third position of the remote device relative to the local device.

3. The method of claim 1, wherein the second magnetic signal includes a second amplitude smaller than a first amplitude of the first magnetic signal.

4. The method of claim 1, further comprising determining a distance and an orientation of the remote device relative to the local device using the first or the second position data.

5. The method of claim 1, further comprising:
periodically receiving the indication signal during a detection of the rapid movement;
continuously transmitting the second magnetic signal in response to the reception of the indication signal until stopping to receive the indication signal; and
receiving a third position data from the remote device based on the second magnetic signal, wherein the third position data indicates a third position of the remote device relative to the local device.

6. A method of receiving reduced power signals at a remote device, comprising:
receiving a first magnetic signal having a first power from a local device;
generating a first position data based on the first magnetic signal;
transmitting the first position data to the local device;
detecting a rapid movement of the remote device, wherein the rapid movement includes a velocity or an acceleration of the remote device exceeding a threshold;
transmitting an indication signal indicating a detection of the rapid movement of the remote device in response to detecting the rapid movement;
receiving a reduction signal indicating a reduction in the first power of the first magnetic signal based on transmitting the indication signal;
receiving a second magnetic signal based on receiving the reduction signal, wherein the second magnetic signal has a second power lower than the first power;
generating a second position data based on the second magnetic signal; and
transmitting the second position data to the local device.

7. The method of claim 6, further comprising determining a distance and an orientation of the remote device relative to the local device using the first or the second position data.

8. The method of claim 7, further comprising determining the orientation of the remote device using data from a gyroscope.

9. The method of claim 6, further comprising:
detecting an end of the rapid movement;
transmitting a restoration signal in response to detecting the end of the rapid movement to the local device;
receiving an augmentation signal indicating an increase in the second power of the second magnetic signal;
receiving the first magnetic signal based on receiving the augmentation signal; and
generating a third position data based on the first magnetic signal.

10. The method of claim 6, wherein detecting the rapid movement further comprises measuring a movement of the remote device using an accelerometer.

11. A local device, comprising:
one or more processors:
a memory having instructions stored therein, wherein the instructions, when executed by the one or more processors, are configured to:
transmit a first magnetic signal to a remote device;
receive a first position data from the remote device based on the first magnetic signal, wherein the first position data indicates a first position of the remote device relative to the local device;
receive an indication signal indicating a rapid movement, wherein the rapid movement includes a velocity or an acceleration of the remote device achieving a threshold;
transmit a reduction signal indicating a reduction in a first power of the first magnetic signal in response to receiving the indication signal;
transmit a second magnetic signal based on transmitting the reduction signal, wherein the second magnetic signal has a second power lower than the first power; and
receive a second position data from the remote device based on the second magnetic signal, wherein the second position data indicates a second position of the remote device relative to the local device.

12. The local device of claim 11, wherein the one or more processors are further configured to:
receive a restoration signal;
transmit an augmentation signal indicating an increase in the second power of the second magnetic signal in response to receiving the restoration signal; and
transmit the first magnetic signal at the first power based on transmitting the augmentation signal; and
receive a third position data from the remote device based on the first magnetic signal, wherein the third position data indicates a third position of the remote device relative to the local device.

13. The local device of claim 11, further comprising a modulator that reduces an amplitude of the first magnetic signal to produce the second magnetic signal.

14. The local device of claim 11, wherein the one or more processors are further configured to:
periodically receive the indication signal during the detection of the rapid movement;
continuously transmit the second magnetic signal in response to the reception of the indication signal; and
receive a third position data from the remote device based on the second magnetic signal, wherein the third position data indicates a third position of the remote device relative to the local device.

15. A remote device, comprising:
an accelerometer configured to detect a rapid movement of the remote device, wherein the rapid movement includes a velocity or an acceleration of the remote device exceeding a threshold;
one or more processors:
a memory having instructions stored therein, wherein the instructions, when executed by the one or more processors, are configured to:
receive a first magnetic signal having a first power from a local device;
generate a first position data based on the first magnetic signal;
transmit the first position data to the local device;
transmit an indication signal indicating a detection of the rapid movement of the remote device in response to detecting the rapid movement;
receive a reduction signal indicating a reduction in the first power of the first magnetic signal based on transmitting the indication signal;
receive a second magnetic signal based on receiving the reduction signal, wherein the second magnetic signal has a second power lower than the first power;
generate a second position data based on the second magnetic signal; and
transmit the second position data to the local device.

16. The remote device of claim 15, wherein the one or more processors are further configured to determine a distance and an orientation of the remote device relative to the local device using the first or the second position data.

17. The remote device of claim 16, further comprising a gyroscope configured to determine the orientation of the remote device.

18. The remote device of claim 15, wherein the one or more processors are further configured to:
detect an end of the rapid movement;
transmit a restoration signal in response to detecting the end of the rapid movement to the remote device;
receive an augmentation signal indicating an increase in the second power of the second magnetic signal;
receive the first magnetic signal based on receiving the augmentation signal; and
generate a third position data based on the first magnetic signal.

19. A method of sending reduced power signals using a remote device, comprising:
transmitting a first magnetic signal having a first power to a local device;
detecting a rapid movement at the remote device, wherein the rapid movement includes a velocity or an acceleration of the remote device exceeding a threshold;
transmitting a reduction signal indicating a decrease in the first power of the first magnetic signal based on detecting the rapid movement; and
transmitting a second magnetic signal having a second power based on transmitting the reduction signal, wherein the second power is lower than the first power.

20. The method of claim 19, further comprising:
detecting an end of the rapid movement;
transmitting an augmentation signal indicating an increase in the second power of the second magnetic signal; and
transmitting the first magnetic signal.

21. The method of claim 19, wherein the second magnetic signal includes a second amplitude smaller than a first amplitude of the first magnetic signal.

22. The method of claim 19, further comprising:
periodically transmitting the reduction signal during the detection of the rapid movement; and
continuously transmitting the second magnetic signal in response to the transmission of the reduction signal until detecting an end of the rapid movement.

23. A method of receiving reduced power signals at a local device, comprising:
receiving a first magnetic signal having a first power from a remote device;
generating a first position data based on the first magnetic signal, wherein the first position data indicates a first position of the remote device relative to the local device;
receiving a reduction signal indicating a reduction in the first power of the first magnetic signal;
receiving a second magnetic signal based on receiving the reduction signal, wherein the second magnetic signal has a second power lower than the first power of the first magnetic signal; and
generating a second position data based on the second magnetic signal, wherein the second position data indicates a second distance and a second orientation of the remote device relative to the local device.

24. The method of claim 23, further comprising determining a distance and an orientation of the remote device relative to the local device using the first or the second position data.

25. The method of claim 24, further comprising determining the orientation of the remote device using data from a gyroscope.

26. The method of claim 23, further comprising:
receiving an augmentation signal indicating an increase in the second power of the second magnetic signal; and
receiving, based on receiving the augmentation signal, the first magnetic signal.

27. A remote device, comprising:
one or more processors:
an accelerometer configured to detect a rapid movement at the remote device, wherein the rapid movement includes a velocity or an acceleration of the remote device exceeding a threshold;
a memory having instructions stored therein, wherein the instructions, when executed by the one or more processors, are configured to:
transmit a first magnetic signal having a first power to a local device,
transmit a reduction signal indicating a decrease in the first power of the first magnetic signal based on detecting the rapid movement, and
transmit a second magnetic signal having a second power based on transmitting the reduction signal, wherein the second power is lower than the first power.

28. The remote device of claim 27, further comprising instructions, when executed by the one or more processors, configured to:
detect an end of the rapid movement,
transmit an augmentation signal indicating an increase in the second power of the second magnetic signal, and
transmit the first magnetic signal.

29. The remote device of claim 27, wherein the second magnetic signal includes a second amplitude smaller than a first amplitude of the first magnetic signal.

30. The remote device of claim 27, further comprising instructions, when executed by the one or more processors, configured to:
periodically transmit the reduction signal during the detection of the rapid movement, and
continuously transmit the second magnetic signal in response to the transmission of the reduction signal until detecting an end of the rapid movement.

31. A local device, comprising:
one or more processors:
a memory having instructions stored therein, wherein the instructions, when executed by the one or more processors, are configured to:
receive a first magnetic signal having a first power from a remote device;
generate a first position data based on the first magnetic signal, wherein the first position data indicates a first position of the remote device relative to the local device;
receive a reduction signal indicating a reduction in the first power of the first magnetic signal;
receive a second magnetic signal based on receiving the reduction signal, wherein the second magnetic signal has a second power lower than the first power of the first magnetic signal; and
generate a second position data based on the second magnetic signal, wherein the second position data indicates a second distance and a second orientation of the remote device relative to the local device.

32. The local device of claim 31, further comprising instructions, when executed by the one or more processors, configured to determine a distance and an orientation of the remote device relative to the local device using the first or the second position data.

33. The local device of claim 32, further comprising instructions, when executed by the one or more processors, configured to determine the orientation of the remote device using data from a gyroscope.

34. The local device of claim 31, further comprising instructions, when executed by the one or more processors, configured to:
receive an augmentation signal indicating an impending increase in the second power of the second magnetic signal; and
receive, after the reception of the augmentation signal, the first magnetic signal.

35. The local device of claim 31, further comprising instructions, when executed by the one or more processors, configured to receive an augmentation signal indicating an impending increase in the second power of the second magnetic signal.
